(19) United States
(12) Patent Application Publication
(10) Pub. No.: US 2015/0184630 A1
(43) Pub. Date: Jul. 2, 2015

(54) WIND POWER STATION

(71) Applicants: Suren Tatikyan, Hrazdan (AM); Tigran Tatikyan, Yerevan (AM)

(72) Inventors: Suren Tatikyan, Hrazdan (AM); Tigran Tatikyan, Yerevan (AM)

(21) Appl. No.: 14/415,889

(22) PCT Filed: Dec. 24, 2012
(86) PCT No.: PCT/AM2012/000007

§ 371 Date: Jan. 20, 2015

(30) Foreign Application Priority Data
Jul. 21, 2012 (AM) AM201201 10U

(51) Int. Cl. F03D 3/04; F03D 3/00; F03D 9/00

(52) U.S. Cl. CPC F03D 3/0427; F03D 9/002; F03D 3/005

(57) ABSTRACT

Wind power station, which has a turnable body, rotor which has vertically installed shaft mounted with working wheels, wind concentrator. The body is designed with an ability of positioning the self-mounted wind concentrator to the wind direction. The wind concentrator is multistage and is composed of a least two air flow consequentially located concentrators. The entrance cross-section of the concentrators is smaller than their exit cross-section, and there are air flow gaps between the consequentially located concentrators.

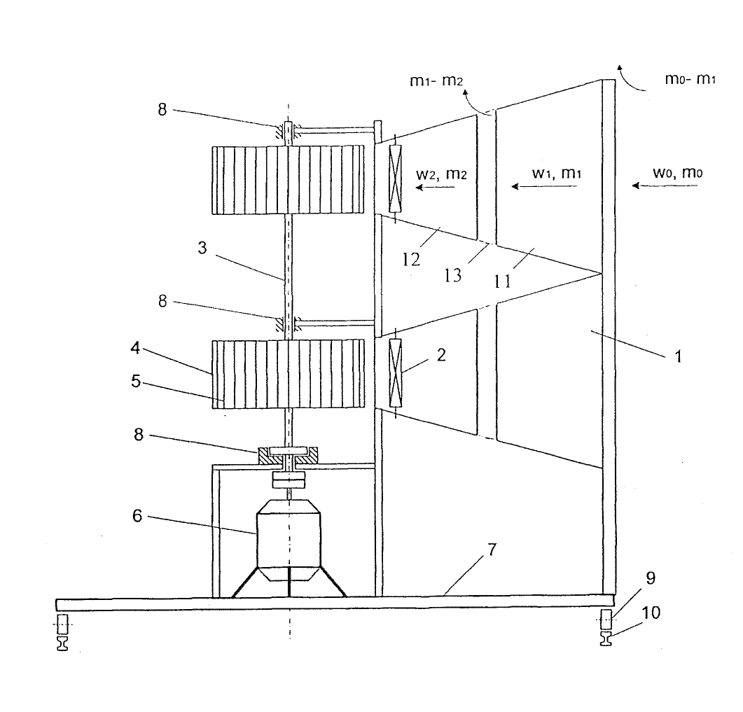

### TECHNICAL FIELD

Invention relates to wind motor and can be used in the field of wind power.

### BACKGROUND ART

Known wind power station, which has a turnable body, rotor which has vertically installed shaft mounted with working wheels, wind concentrator ([AM 2245A, F03D 3/00, F03D 7/00, 2008]—closest imitation). The shortcoming of the known design is that the increase of air speed in the concentrator is limited, and from the certain value of concentrator entry and exit cross-section ratio the further increase do not result the air speed rising.

### DISCLOSURE OF INVENTION

The task of the invention is to increase the air speed which is given to the wind power station working wheels.

The essence of the invention is that in the wind power station, which has a turnable body, rotor which has vertically installed shaft mounted with working wheels, wind concentrator, the body is designed with an ability of positioning the self-mounted wind concentrator to the wind direction. The wind concentrator is multistage and is composed of at least two air flow consequentially located concentrators. The entrance cross-section of the concentrators is smaller than their exit cross-section, and there are air flow gaps between the consequentially located concentrators.

### BRIEF DESCRIPTION OF DRAWINGS

The essence of the invention has been clarified by the FIGURE, where is the fundamental structure of the wind power station.

### DESCRIPTION OF EMBODIMENTS

The wind power station has a multistage wind concentrator (1) mounted on a turnable body, on the exit of which are located adjustable gates (2) regulating air quantity and flow direction, On a vertically installed shaft (3) are mounted working wheels(4), around of which are located the working blades (5). Shaft rotation is transferred to the electrical generator (6). Wind concentrator and generator stator are installed on the body (7), and the shaft position is fixed to the body through the bearings (8). Wheels (9) carrying the weight of body, are moving by the circular track (10).

The wind concentrator is multistage and is composed of at least two air flow consequentially located concentrators. The entrance cross-section of the concentrators is smaller than their exit cross-section. Between the first (11) and second (12) consequentially located concentrators there are gaps (13) for the removal of the part of air flow.

Wind power station work as follows:

The stations body is turnable by the wind power stations automatic system and moves in circular track so that the wind multistage concentrator takes counter (cross) position to the wind. Part m₂ of the air stream passing through the concentrator and adjustable gates is given to the working wheel blades with the speed w₂ and in the best direction. The main part of the energy of air flow is transferred to the working blades and air is coming out from the station with minimum speed.

The air mass m₀, coming to the entrance of the first concentrator (11) due to wind by the speed w₀, partialy at mass m₁ passes through the concentrator, gaining speed w₁, and partialy at mass m₀-m₁ decelerating bypass the concentrator (11) transferring its braking energy to the mass m₁. Air mass m₁ by the speed w₁ approaching to the entrance of the second concentrator (12) partialy at mass m₂ passes through the concentrator, gaining speed w₂, and partialy at mass m₁-m₂ decelerating bypass the concentrator (12) through the air gap (13) transferring its braking energy to the mass m₂.

The wind power station gives an opportunity to build powerful wind power stations with relatively small diameter of rotating parts.

1. A wind power station, which has a body, a rotor with wheels attached to the vertically installed shaft, and a wind concentrator, the body is rotatable and enables the concentrator attached thereon to follow the wind direction; characterized in that the wind concentrator is multistage, and is composed of at least two air flow consequentially located concentrators, the entrance cross-section of the concentrators is smaller than their exit cross-section, and there are air flow gaps between the consequentially located concentrators.
